(19) United States
(12) Patent Application Publication
(10) Pub. No.: US 2026/0116589 A1
(43) Pub. Date: Apr. 30, 2026

(54) RESCUE DRONE

(71) Applicants: Daniel J. Good, Tequesta, FL (US); Kevin Good, Tequesta, FL (US)

(72) Inventors: Daniel J. Good, Tequesta, FL (US); Kevin Good, Tequesta, FL (US)

(21) Appl. No.: 19/413,468

(22) Filed: Dec. 9, 2025

Related U.S. Application Data
(63) Continuation-in-part of application No. 18/191,487, filed on Mar. 28, 2023, now Pat. No. 12,509,197.

(51) Int. Cl. B64U 20/87; B64U 10/16; B64U 60/10; B64U 101/57; B66D 3/26

(52) U.S. Cl. CPC B64U 20/87; B64U 10/16; B64U 60/10; B66D 3/26; B64U 2101/57; B64U 2201/20

(57) ABSTRACT

A remote control drone assembly to assist in the rescue of distressed swimmers. The drone assembly includes a flotation device that can be released over a distressed swimmer. A retractable spool assembly attached to the drone assembly includes a retrieval line having a proximate end tethered to the spool assembly. The drone assembly is constructed and arranged to be flown by an operator over a distressed swimmer. The floatation device is released for use by the distressed swimmer and the drone assembly is returned to the operator. The retractable spool is detached from the drone assembly and attached to a spool retractor. The spool retractor retrieving the floatation device together with the distressed swimmer.

### PRIORITY CLAIM

In accordance with 37 C.F.R. 1.76, a claim of priority is included in an Application Data Sheet filed concurrently herewith. Accordingly, the present invention is a continuation-in-part (CIP) of U.S. patent application Ser. No. 18/191,487 entitled RESCUE DRONE, filed Mar. 28, 2023 the contents of which is incorporated herein by reference.

### FIELD OF THE INVENTION

This invention is directed to the field of drones, also referred to as UAV and UAS (Unmanned Aerial Vehicle and Unmanned Aerial System) and, in particular, to a drone capable of releasing a floatation device for use in combination with a retriever mechanism to assist a swimmer in distress.

### BACKGROUND OF THE INVENTION

The ability to rescue an individual that has fallen into a large body of water depends on a number of variables. For example, recovering an individual that falls off a large cruise ship can be problematic as it can take upwards of one mile to stop or turn a cruise ship around. In the period of time it takes to stop or turn around a cruise ship, the fallen individual may drift with the current making it difficult if not impossible to spot the individual from a mile away. If the individual is has no floatation device, or is a poor swimmer, the period of time for a successful rescue maybe minutes. The problem with a man overboard is not limited to cruise ships, commercial boats can lose crew members on tankers, freighters, long line fishing boats and crab fishing boats and so forth. Even recreational vessels, such as a large sailboat, can have a man overboard situation wherein the vessel is difficult to stop and return to the fallen individual.

The safety of individuals in the water is not limited to far offshore situations. An otherwise inviting beachfront visit can have life threatening consequences if an individual is caught in a rip current. Within minutes an individual can be drawn out away from the shoreline. In many such instances the individual is unprepared for such an event and can panic risking exhaustion and drowning. If the individual is pulled into a rip current at a beach monitored by a lifeguard, the lifeguard will hopefully reach the swimmer in sufficient time but at a risk to the lifeguard.

Getting timely help to a man overboard is critical. High seas and icy cold water are but a few conditions that shorten the time for a successful rescue. The individual in need of rescue is often in a desperate position posing a danger to potential rescuers. Additionally, an individual in need of rescue may be a significant distance away from the rescuer or be in a situation where an attempted rescue puts additional individuals at risk.

U.S. Coast Guard has a mission, known as Search and Rescue (SAR), to minimize the loss of life, injury and property damage by rendering aid to persons in distress. Despite the use of advanced equipment including airplanes and boats linked by specialty communication networks, there are many instances where an attempted rescue becomes too great of a risk for even the highly trained servicemen. For instance, if the seas are rough, filled with debris or ice cold, a rescue attempt will put the rescuer at great risk. Even with advanced military training, an individual is still susceptible to injury while performing their duties. In instances where a helicopter is used, the propeller wash can place all those aboard the helicopter at risk. A number of prior art references directed to the rescue devices exist.

U.S. Pat. No. 7,546,187 discloses a method for navigating a drone having an on-board digital camera. Embodiments include identifying a geographic area not captured by the digital camera while the drone is flying.

U.S. Pat. No. 7,130,741 discloses a remote control with a user's selection of a GUI map pixel that represents a waypoint for UAV navigation, the pixel having a location on the GUI; mapping the pixel's location on the GUI to Earth coordinates of the waypoint; receiving a starting position from a GPS receiver on the UAV; calculating a heading in dependence upon the starting position, the coordinates of the waypoint, and a navigation algorithm; identifying flight control instructions for flying the UAV on the heading; and transmitting the flight control instructions from the remote control device to the UAV.

U.S. Pat. No. 7,755,496 discloses a system for directing a lost person to a predetermined location for pickup including a tethered balloon or other highly visible signal deployed at the pickup location. A manned or remotely controlled aircraft is provided for flying over the area in which the lost person is presumed to be located. The aircraft is equipped with a downward directed loudspeaker broadcasting an audible message instructing the lost person to walk towards the balloon or other signal at the rescue location. The aircraft may be a fixed-wing or rotary-wing aircraft, and airship such as a dirigible or blimp, an ultralight, or a hybrid aircraft.

U.S. Pat. No. 8,882,555 discloses a remote controlled motorized buoy for rescuing people in the water. The buoy may be controlled by a person with a remote control to navigate to the person in need. The buoy may have flotation mechanisms to keep the buoy right side up in rough water conditions and includes visual indicators to help the user keep track of the buoys location, such as a flag and beacon. When the buoy is near the swimmer, the swimmer may grab the buoy and the buoy may be remotely navigated to bring the swimmer to a safe location.

U.S. Pat. No. 8,646,719 discloses an unmanned, towable air vehicle is described and includes electronic sensors to increase the detection range relative to the horizon detection limitations of a surface craft, an autogyro assembly to provide lift, and a controller to control operation the autogyro assembly for unmanned flight. A forward motive force powers the autogyro assembly to provide lift. In an example, the autogyro assembly includes a mast extending from the container, a rotatable hub on an end of the mast, and a plurality of blades connected to the hub for rotation to provide lift to the vehicle. In an example, an electrical motor rotates the blades prior to lift off to assist in take off. The electrical motor does not have enough power to sustain flight of the vehicle in an example.

U.S. Pat. No. 8,869,671 discloses a spring-driven linkage for deploying one or more kicker feet, to push a device to be deployed away from a UAV deployment system. The kicker feet may include fore and aft kicker feet that push the deployed device to obtain a desire pitch in the launch, an example being a minimal or substantially zero pitch. The release of the kicker feet may be controlled by a pair of actuator, such as electrical solenoid actuators, both of which must be actuated to deploy the device. An electrical connection may allow positional float to account for tolerances in the positioning of the device relative to the deployment system.

U.S. Pat. No. 7,344,426 discloses a rescue system which includes a mobile trailer on which are mounted telescoping hydraulic arms and a winch. A net is connected to the winch and passes over a roller mounted at the outer ends of the hydraulic arms which are vertically and horizontally movable to position the net over the body of water. The net hangs downwardly from the roller into the body of water. A ballast is attached at the lower end of the net so that the net is vertically oriented in the water. A rope connected to the lower end of the net and a set of pulleys enable the lower end of the net to be lifted to envelope a person therein. When the person is enveloped in the net, the winch is actuated via an electric motor to reel in the net and lift the net and the person out of the body of water and to a place of safety.

U.S. Pat. No. 10,059,448 discloses a rescue device based upon a drone equipped with a deployable life preserver or other buoyant device. The drone used a vacuum pump connected to a suction cup for holding of a buoyant floatation member.

U.S. Publication 2020/0031438 discloses a rescue drone system that includes a buoyant body member, a frame attached to the buoyant body member for carrying a motor, propeller, and electronic array. A laser guidance system may provide coordinates for landing near a swimmer in distress. In one embodiment the drone system can take off and land vertically with propellers rotating in a horizontal plane, and propellers can pivot to rotate in a vertical plane for propulsion across water similar to a fan boat with rescued people aboard.

What is needed in the art is an improved method for rescuing an individual at sea without placing the rescuer at risk, or otherwise adding to the hazardous conditions. Various attempts have been made to accomplish remote rescues on land and on sea by use of a drone, each with various results.

### SUMMARY OF THE INVENTION

Disclosed is a remote control drone assembly for use in assisting in distressed swimmers and the like individuals stranded in water in need of rescue. The drone assembly having a plurality of rotor assemblies and a power source secured to a frame member, including a wireless controller for operational control of the drone assembly. A frame mounted camera transfers images for viewing on a screen coupled to the wireless controller. A retractable spool assembly is releasably attached to the frame member. The retractable spool assembly including a 300 lb retrieval having a length of at least 1 mile and preferably at least 1 mile long. One end of the retrieval is tethered to the spool assembly, the distal end of the retrieval is secured to a floatation device. The flotation device is secured to the frame assembly by a release bracket which can deploy the flotation device by operation of the wireless controller.

The drone assembly can be flown by operating the wireless controller to a position over a distressed swimmer and activated to release the floatation device for use by a distressed swimmer. The drone assembly is flown back to the operator of the controller deploying a length of retrieval from the spool to accommodate the distance between the spool and the floatation device. The spool assembly is then detached from the drone assembly and coupled to a retractor. The retractor being a battery power motor capable of retrieving the floatation device and the distressed swimmer.

An objective of the instant invention is to provide a drone assembly capable of flying a floatation device to a distressed swimmer or the like individual in need of rescue, and returning the drone assembly to the drone operator wherein a spool retractor allows retrieval of the floatation device and distressed swimmer.

Still another objective of the invention is to provide a drone assembly having a tethered retrieval preferably about one mile long and evenly spooled by a level wind device operated by a spool retractor.

Yet still another objective of the invention is to provide a rescue apparatus that can be operated like a conventional drone with the advantage of returning a retrieval from a deployed floatation device assembly for coupling to a spool retractor capable of retrieving the floatation device and distress swimmer.

Still another objective of the invention is to teach the use a variable speed driver for a retractor, the driver constructed and arranged to receive the spool assembly and retrieval line at the operator's discretion. For instance, high speed retraction if the operator is headed to the distressed swimmer in a boat. Low speed retraction or even further deployment if the operator is on a cruise vessel that has yet to reverse course.

Other objectives and further advantages and benefits associated with this invention will be apparent to those skilled in the art from the description, examples and claims which follow.

### BRIEF DESCRIPTION OF THE DRAWINGS

FIG. 1 is a pictorial view of the device with a distressed swimmer;

FIG. 2 is a lower perspective view of the rescue drone system;

FIG. 3 is a lower perspective view without a floatation element;

FIG. 4 is a left front perspective view of the spool;

FIG. 5 is a right front perspective of the spool;

FIG. 6 is a right rear perspective view of the spool;

FIG. 7 is a top right perspective view of the hand held retriever;

FIG. 8 is a right plane view of the hand held retriever;

FIG. 9 is a top plane view of the hand held retriever;

FIG. 10 is an upper perspective view of the rescue drone system;

FIG. 11 is an upper left perspective view of the rescue drone system without the floatation element;

FIG. 12 is an upper right perspective view of the rescue drone system without the floatation element;

FIG. 13 is a bottom plane view of the rescue drone system without the floatation element;

FIG. 14 is a plane view of the support arm.

FIG. 15 is a perspective view of a belt driven retractor.

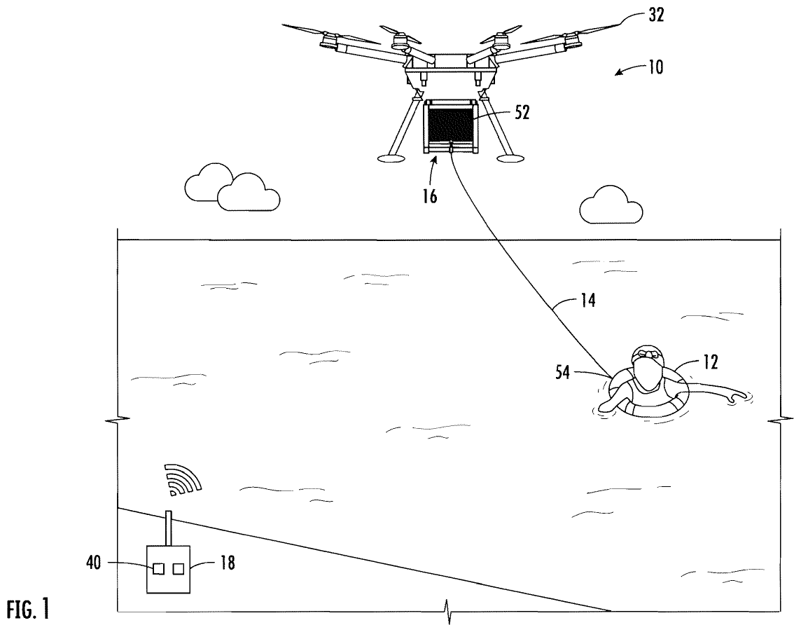

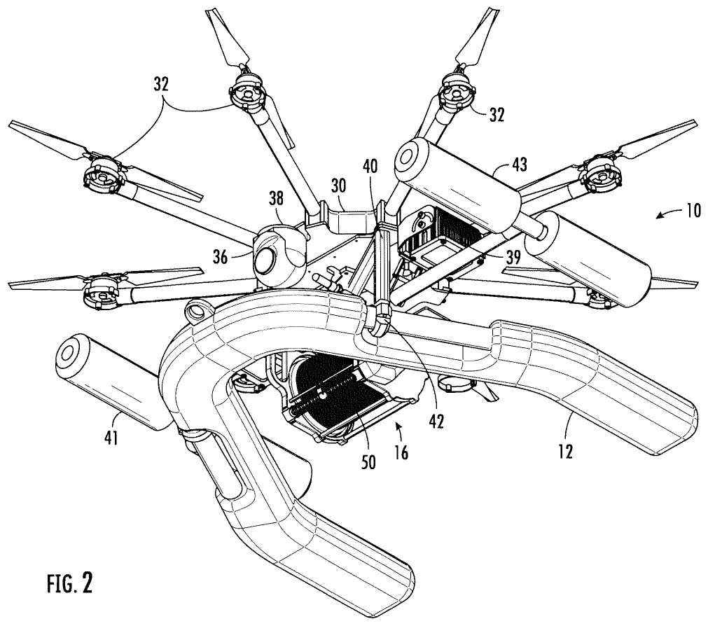

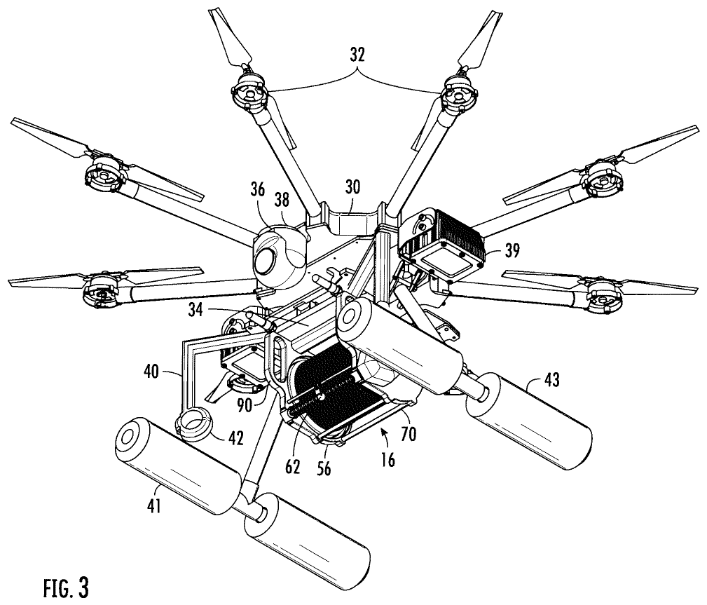

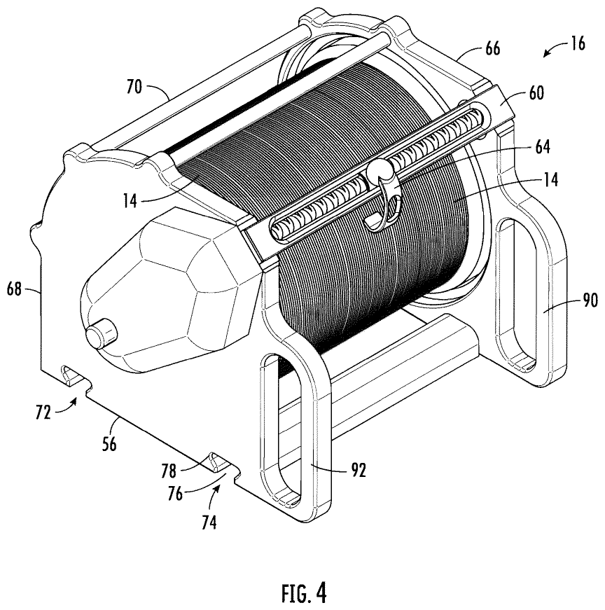

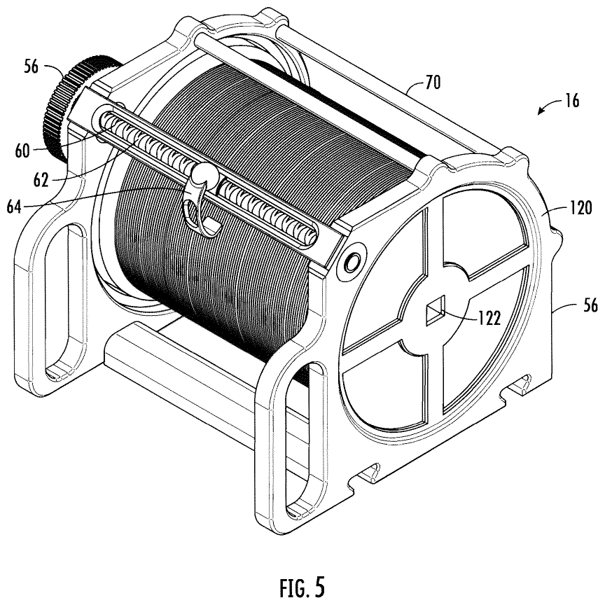

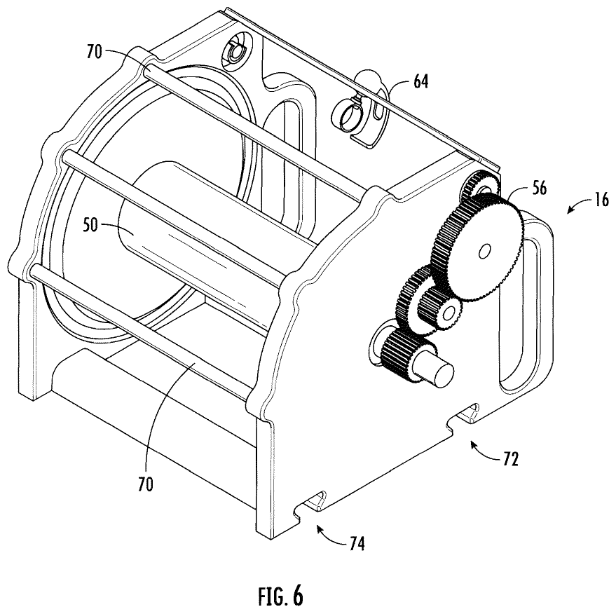

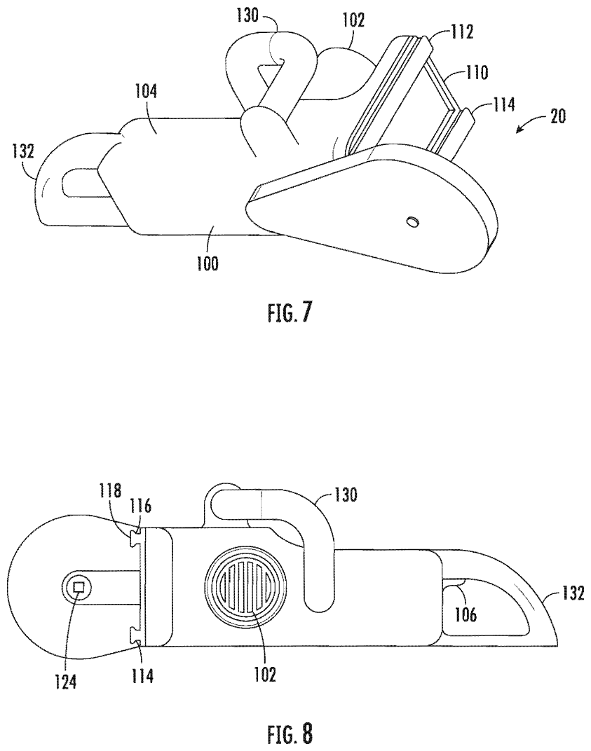

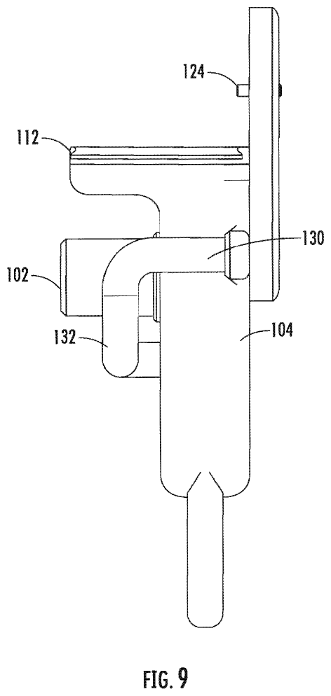

### DETAILED DESCRIPTION OF THE PREFERRED EMBODIMENT

Detailed embodiments of the instant invention are disclosed herein, however, it is to be understood that the disclosed embodiments are merely exemplary of the invention, which may be embodied in various forms. Therefore, specific functional and structural details disclosed herein are not to be interpreted as limiting, but merely as a basis for the claims and as a representation basis for teaching one skilled in the art to variously employ the present invention in virtually any appropriately detailed structure.

Referring now to the Figures, discloses is a remote control drone assembly for assisting distressed swimmers and the like water rescues. The drone assembly 10 includes a flotation device 12 that can be released over a distressed swimmer tethered by a retrieval 14 to a releasably attached spool assembly 16. The drone assembly 10 is operated by a wireless controller 18 for deploying and retrieving the drone assembly 10. A handheld retriever 20 accepts the spool assembly 16 and allows the operator to retrieve the tethered flotation device 12.

The drone assembly 10 consists of a frame member 30 having a plurality of rotor assemblies 32 and a power source 34 secured thereto. A camera 36 is attached to the frame member 30 with a modem 38 for transferring images for viewing on a screen 40 coupled to a wireless controller 18. The wireless controller 18 operating in a conventional format for controlling the elevation, direction and forward speed of the drone assembly 10. The camera 36 provides remote viewing to assist in locating the distressed swimmer. The camera 36 may be conventional using lights for night time illumination and/or forward looking infrared (FLIR). In one embodiment the FLIR provides thermal infrared imaging sensors to detect swimmers regardless of the light. Remotely lights 37, 39 can be used to illuminate the rescue/landing zone wherein the swimmer can locate the floatation device in the darkness.

The drone assembly 10 includes a spool assembly is releasably attached to the frame member 30 by use of a release bracket 40. The release bracket 40 having a solenoid operated latch 42 which maintains the floatation device 12 in a position secured to the frame member 30 while in a storage position, and upon activation of the solenoid 42 the floatation device 12 is deployed. When the floatation device 12 is in a storage position, the drone assembly 10 can land on the water. If the floatation device 12 is deployed first pontoons 41 are supported by a first stand 45, and second pontoons 43 are support by a second stand 47. The pontoons operate as landing gear on water wherein the pontoons are constructed and arranged to provide sufficient floatation for the drone 10, alternatively the pontoons operate as a base for landing on solid surfaces.

The spool assembly 16 includes a retrieval line 14 having a proximate end 52 and a distal end 54, the proximate end 52 of the retrieval line 14 is tethered to a spool 50 attached to a spool frame housing 56. The spool assembly 16 includes a gear assembly 56 engaging a level winder 60 having a helix gear 62 for transverse movement of a line pawl 64. The line pawl 64 moveable along the width of the spool 50 to allow an organized collection of the retrieval line 14 during retrieval. The spool frame housing 56 having a first side wall 66 separated by a second side wall 68 by use of a plurality of frame support rods 70. Along the bottom of the first 66 and second side wall 68 is an inner track mounting guide 72 and an outer track mounting guide 74. In one embodiment the mounting guides 72, 74 form a receptacle with each having an opening 76 leading to an expanded sidewall 78. The opening 76 and expanded sidewall 78 of each said mounting guide 72, 74 are slidably attached to reciprocal protrusions 80, 82 extending from the bottom of the frame 30. The protrusion having a head portion 84 that fits within the expanded sidewall 78 and a neck portion 86 that fits within the opening 76. The side walls 66, 68 having integrated lifting handles 90, 92 for ease of attachment and removal from either the frame 30.

The spool retractor 20 has a frame 100 with a variable speed drive motor 102 electrically coupled to a rechargeable battery 104. The speed of the motor 102 can be varied by depressing of a control switch 106. The greater the depression of the switch 106, the greater the rotational speed of the drive motor 102. The frame 100 includes a bracket 110 for receipt of the retractable spool assembly 16 namely an upper protrusion 112 and a lower protrusion 114. Each protrusion is similar to the drone assembly protrusions having a neck portion 116 and a head portion 118. The protrusions 112, 114 are constructed and arranged to engage the retractable spool assembly 16 mounting guides 72, 74. It should be noted that the engagement mechanism can be reversed, namely the receptacles can be formed on the retractor spool and drone assembly 10 with the protrusions on the spool assembly 16.

A first end 120 of the spool assembly 16 has a drive socket 122 coupled to a driver 124 rotated by the drive motor 102. The retrieval line 14 can be withdrawn by wrapping around the spool 50 when the drive motor 102 is operated. The spool 50 engages the level winder 60 having a helix gear 62 for transverse movement of the line pawl 64. The line pawl 64 moveable along the width of the spool 50 to allow an organized collection of the retrieval line 14 during retrieval. Spool frame housing 56 having a first side wall 66 separated by a second side wall 68 by use of a plurality of frame support rods 70. Tension on the spool 50 is used to prevent free wheeling which can cause retrieval line entanglement or lead to a birds nest. The frame includes a forward hand grip 130 and an aft hand grip 132.

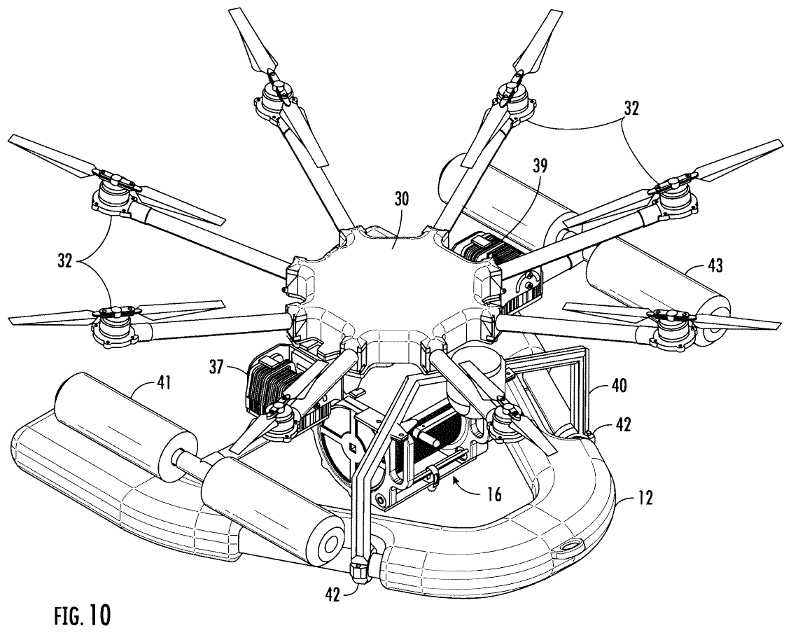

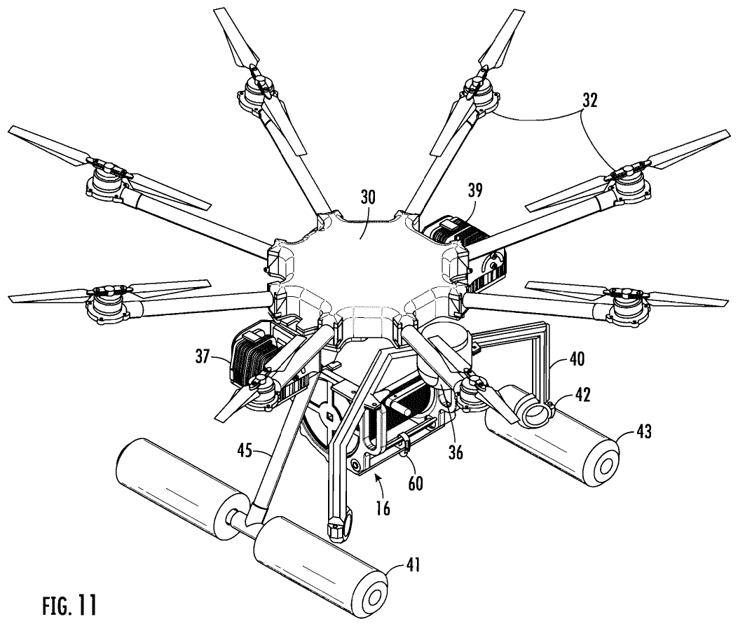

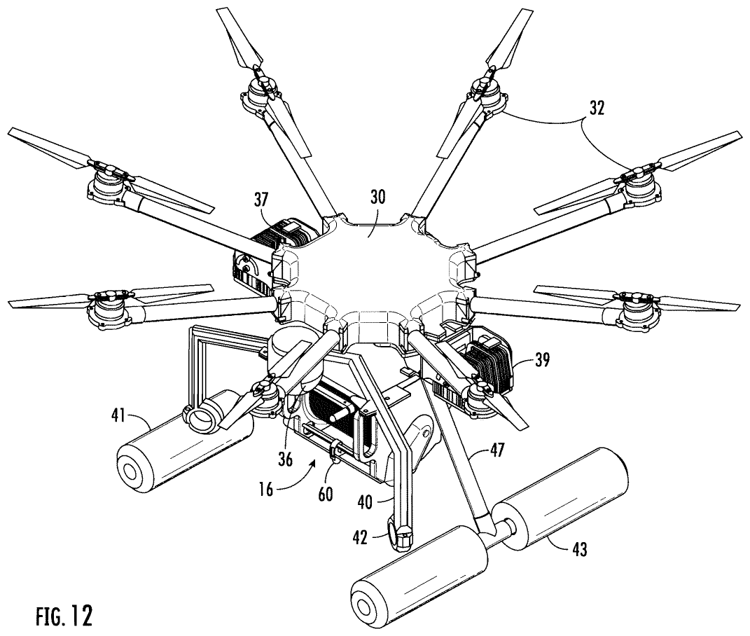

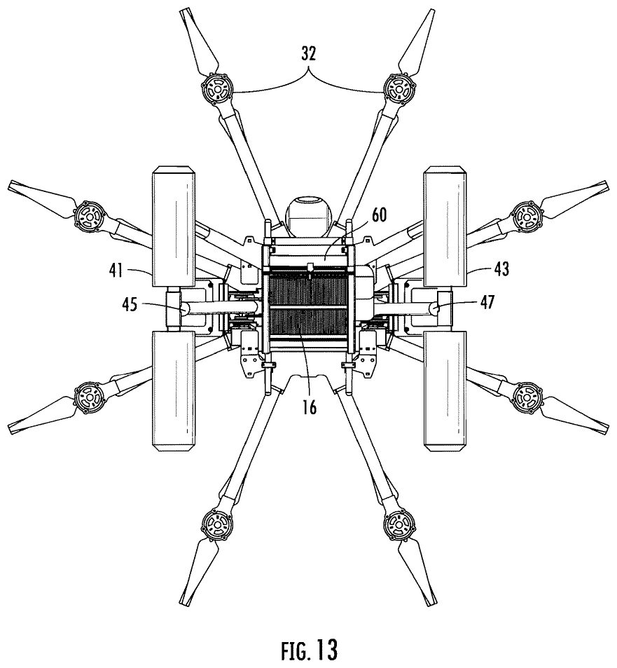

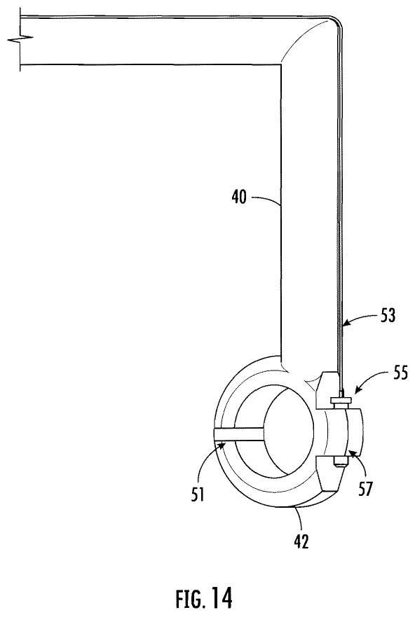

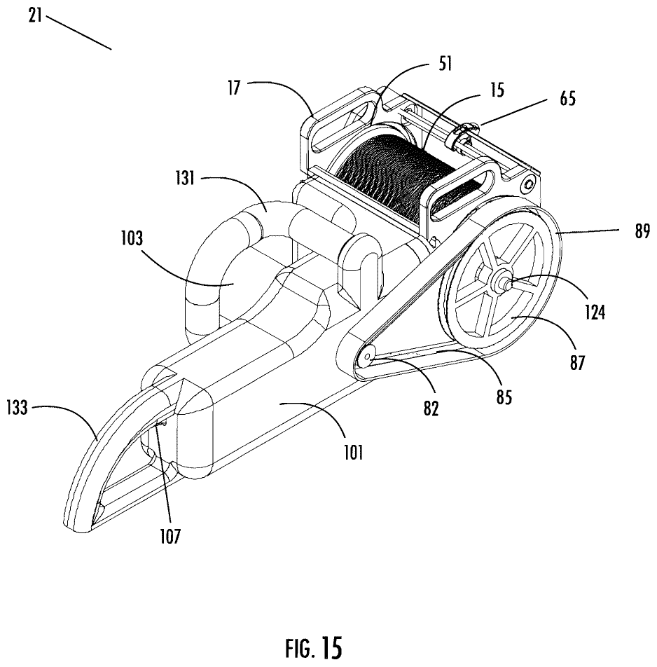

FIGS. 9-12 depict the rescue drone assembly 10 with the floatation device 12 tethered by a retrieval line 14 to the releasably attached spool assembly 16. An end of the retrieval line 14 is attached to a coupling point 17 of the floatation device 12. The floatation device 12 including bars 19, 21 to provide a gripping surface for the individual in need of recovery. The floatation device 12 may be constructed of foam, hollow plastic, or be formed of an inflatable bladder with the intent of providing a lightweight floatation device. It is note that the floatation device requires sufficient weight and shape so as limit the effect of wind on the device when released from the assembly. The drone assembly 10 is based upon a frame member 30 supported by a plurality of rotor assemblies 32. In a preferred embodiment, eight rotor assemblies 32 are equally spaced apart, the rotor assemblies are constructed and arranged to support the weight of the assembly including flotation device 12 and releasable spool assembly 16 via an electric motor 15. The camera 36 is positioned on the front of the frame 30 to provide remote viewing of the floatation device 12 to allow remote deployment.

The retractable spool assembly 16 is releasably attached to the frame 30 member by use of a release bracket 40. The release bracket 40 having a solenoid operated latch 42 which maintains the floatation device 12 in a position secured to the frame 30 while in a storage position, and upon activation of the solenoid 42, the floatation device 12 is deployed by opening of a claw 51 by pulling a wire 53 to lift a pin 55 allowing rotation on a hinge 57. When the arms 43 are opened the floatation device 12 is released from the assembly and the retrieval line 14 will begin to spool out as the drone assembly 10 is returned to the drone operator.

In operation, the drone assembly can be flown by operating the wireless controller to a position over a distressed swimmer. The wireless controller can then be used to activate the solenoid used to deploy the floatation device from the release bracket. The drone assembly is then returned to the wireless controller operator wherein retrieval line is deployed from the spool to accommodate the distance between the retractable spool and the floatation device. Once the drone assembly is returned to the operator, the retractable spool assembly is detached from the frame member and attached to the spool retractor. The spool retractor is then used in retrieving the floatation device together with the distressed swimmer.

An alternative embodiment employs a spool retractor 21 for releasably attachment to a frame member 30. With this embodiment, the rescue operation can be executed in two ways. First, after the retrieval line has been unwound, the spool assembly can be transferred from the drone to the retractor/winder, enabling powered retrieval of the retrieval line to bring a person to safety. Alternatively, the spool assembly can stay on the retractor/winder unwinding the retrieval line freely as it remains attached to the drone and buoy, while fling out to a person in need of rescue.

Referring to FIG. 15, the spool retractor 17 is mounted to the frame 101. The spool retractor 17 includes a spool 51 with a line pawl 65 for proper winding of the retrieval line 15. The spool 51 is rotated by the variable speed drive motor 103, powered by a rechargeable battery that rotates a 1″ motor pulley 82. The motor pulley 82 is coupled to a spool drive pulley 87 by a V-belt 85 having a belt guard body 89. The motor 103 is activated the control switch 107. The speed of the motor 103 can be varied by depressing of a control switch 107. The motor driver has a 1″ pulley 82 coupled to a 6″ spool drive pulley 87 using a ½″ adapter 124.

Similar to the previous embodiment, the retrieval line 15 can be withdrawn by wrapping around the spool 51 when the drive motor 103 is operated. The spool 51 engages the line pawl 65 causing movement along the width of the spool to allow an organized collection of the retrieval line 15 during retrieval. Tension on the spool 51 is used to prevent free wheeling which can cause retrieval line entanglement or lead to a birds nest. The retractable spool assembly 17 is releasably attached to the frame 101 member by use of the previously describe release bracket 40. The frame includes a forward hand grip 131 and an aft hand grip 133.

In operation, the drone assembly can be flown by operating the wireless controller to a position over a distressed swimmer. The wireless controller can then be used to activate the solenoid used to deploy the floatation device from the release bracket. The drone assembly is then returned to the wireless controller operator wherein retrieval line is deployed from the spool to accommodate the distance between the retractable spool and the floatation device. Once the drone assembly is returned to the operator, the retractable spool assembly is detached from the frame member and attached to the spool retractor. The spool retractor is then used in retrieving the floatation device together with the distressed swimmer.

The retrieval line length deployed is dependent on the use. For lifeguard use, a length of about 1 mile is suitable. For cruise ship applications, a retrieval line length of about 1 mile is preferred. The longer length of retrieval line necessary to accommodate the distance traveled by the cruise ship once the crew is notified of the man overboard. In the preferred embodiment, the retrieval line has about a 300 lb test strength and floats. A brightly colored or fluorescent floating retrieval line is easier to detect in daylight. For instance, if the floatation device was deployed but the spool ran out of retrieval line before the vessel was turned around, a smaller rescue boat can perform a zig-zag pattern to locate the retrieval line and, once found, and follow the retrieval line to the floatation device. In the preferred embodiment the floatation device is substantially U-shaped, however, traditional round or oblong shape is equally suitable.

A communication device can also be used to provide 2-way audio communication between the swimmer in distress and the operator of the drone. When time is of the essence, the drone assembly will dramatically reduce the amount of time necessary in rescue missions. In many situations a distressed swimmer is at risk and a first responder would further be placed in position of risk during a rescue attempt.

All patents and publications mentioned in this specification are indicative of the levels of those skilled in the art to which the invention pertains. It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A rescue drone system comprising:
a drone assembly including a frame member, a plurality of rotor assemblies secured to the frame member, and a power source coupled to the rotor assemblies, the drone assembly being operable by a wireless controller;
a spool retractor releasably secured to the drone assembly, the spool retractor including a rechargeable battery coupled to a variable speed motor;
a spool assembly mounted to the spool retractor operatively coupled to the motor for rotation of a spool upon activation of the motor, the spool carrying a retrieval line having a proximate end tethered to the spool;
a flotation device releasably secured to the frame member and fastened to a distal end of the retrieval line, the flotation device being configured for release in response to a command from the wireless controller;
wherein, when the drone assembly is positioned over a distressed swimmer, the wireless controller is operable to release the flotation device and the spool retractor is used for retrieval of the flotation device by activation of the motor to rotate the spool.

2. The rescue drone system of claim 1, wherein the spool includes a spool drive pulley and the motor includes a motor pulley coupled together by a V-belt.

3. The rescue drone system of claim 2, wherein the motor pulley is 1-inch diameter and the spool drive pulley is 6-inch diameter.

4. The rescue drone system of claim 1, wherein the retrieval line has a length of approximately one mile and is constructed of a buoyant material.

5. The rescue drone system of claim 1, wherein the retrieval line has a tensile strength of at least 300 pounds.

6. The rescue drone system of claim 1, wherein the retrieval line is colored to enhance visual detection during daylight conditions.

7. The rescue drone system of claim 1, wherein the spool assembly includes a level-wind mechanism configured to distribute the retrieval line evenly across the spool during retraction.

8. The rescue drone system of claim 1, wherein said flotation device is sized to provide sufficient buoyancy to support said drone assembly on water.

9. The rescue drone system of claim 1, further comprising a camera with a modem secured to the frame member and configured to transmit image data to a display coupled to the wireless controller.

10. The rescue drone system of claim 9, wherein said camera includes a transceiver configured for audio communication.

11. A rescue drone system comprising:
a drone assembly including a quad-rotor frame having four rotor assemblies and a rechargeable power source, the drone assembly being remotely controlled by a handheld wireless controller;
a spool retractor unit releasably mounted to an underside of the drone assembly by a quick-release latch, the spool retractor unit including a rechargeable lithium battery electrically connected to a variable-speed motor driver;
a spool assembly fixed to the spool retractor unit and including a cylindrical spool having a drive pulley coupled to the motor driver by a V-belt so that activation of the motor driver rotates the spool, the spool carrying a buoyant retrieval line of at least 300-1b test and having a proximate end secured to the spool;
a flotation device secured to a distal end of the retrieval line and releasably retained on the drone assembly by a solenoid-actuated release mechanism responsive to a command from the wireless controller;
wherein, when the drone assembly is positioned over a distressed swimmer, the wireless controller is operable to release the flotation device such that the spool retractor is used for retrieval of the flotation device by activation of the motor driver to rotate the spool.
